(19) United States
(12) Patent Application Publication
(10) Pub. No.: US 2022/0090848 A1
(43) Pub. Date: Mar. 24, 2022

(54) REFRIGERATOR

(71) Applicant: Toshiba Lifestyle Products & Services Corporation, Kawasaki-shi (JP)

(72) Inventors: Hiromichi MOTOI, Owariasahi-shi (JP); Koichi AKIYOSHI, Kasuga-shi (JP); Kengo MATSUNAGA, Nagoya-shi (JP)

(73) Assignee: Toshiba Lifestyle Products & Services Corporation, Kawasaki-shi (JP)

(21) Appl. No.: 17/420,836

(22) PCT Filed: Jan. 6, 2020
(86) PCT No.: PCT/JP2020/000038

§ 371 Date: Jul. 6, 2021

(30) Foreign Application Priority Data
Jan. 7, 2019 (JP) 2019-000858

(51) Int. Cl. F25D 23/06; F25D 11/02; F25D 25/02; F16L 59/02

(52) U.S. Cl. CPC F25D 23/062; F25D 11/022; F25D 2201/12; F16L 59/028; F25D 25/021

(57) ABSTRACT

A refrigerator includes a housing and a first partition portion. The housing includes a first storage chamber. The first partition portion is disposed in the first storage chamber and partitions the inside of the first storage chamber into at least a first storage portion and a second storage portion which is cooled to a temperature zone lower than that of the first storage portion. At least a part of the first partition portion is formed of a heat-insulating material containing an aerogel, a xerogel, or a cryogel.

### TECHNICAL FIELD

Embodiments of the present invention relate to a refrigerator. Priority is claimed on Japanese Patent Application No. 2019-000858 filed in Japan on Jan. 7, 2019, the content of which is incorporated herein by reference.

### BACKGROUND ART

A refrigerator including a partition portion which partitions a storage chamber into a plurality of storage portions having different temperatures is known. Incidentally, refrigerators are desired to have further improvement in heat insulation.

### CITATION LIST

### Patent Literature

### Patent Literature 1

Japanese Unexamined Patent Application, First Publication No. 2004-340420

### SUMMARY OF INVENTION

### Technical Problem

An object to be solved by the present invention is to provide capable of improving of heat insulation.

### Solution to Problem

A refrigerator of the embodiment includes a housing and a first partition portion. The housing includes a first storage chamber. The first partition portion is disposed in the first storage chamber and partitions the inside of the first storage chamber into at least a first storage portion and a second storage portion which is cooled to a temperature zone lower than that of the first storage portion. At least a part of the first partition portion is formed of a heat-insulating material containing an aerogel, a xerogel, or a cryogel.

### BRIEF DESCRIPTION OF DRAWINGS

FIG. 1 is a front view showing a refrigerator of a first embodiment.

FIG. 2 is a cross-sectional view along line F2-F2 of FIG. 1.

FIG. 3 is a perspective view showing a schematic configuration of the refrigerator of the first embodiment.

FIG. 4 is a cross-sectional view showing the refrigerator of the first embodiment.

FIG. 5 is a bottom view of a partition wall upper member of a partition wall of the first embodiment as viewed from below.

FIG. 6 is a cross-sectional view showing a refrigerator of a modified example of the first embodiment.

FIG. 7 is a cross-sectional view showing a refrigerator of a second embodiment.

FIG. 8 is a cross-sectional view showing a refrigerator of a third embodiment.

FIG. 9 is a cross-sectional view showing a refrigerator of a fourth embodiment.

FIG. 10 is a cross-sectional view showing a refrigerator of a fifth embodiment.

FIG. 11 is a cross-sectional view showing a refrigerator of a sixth embodiment (cross section corresponding to F11-F11 of FIG. 1).

FIG. 12 is a top view of a second partition wall of the refrigerator of the sixth embodiment.

FIG. 13 is a cross-sectional view showing a small freezing chamber door and a second partition wall of a refrigerator of a seventh embodiment.

FIG. 14 is a view of a front surface member of the refrigerator of the seventh embodiment from the front of the refrigerator.

FIG. 15 is a cross-sectional view showing a first insulating member of a refrigerator of a first modified example of the seventh embodiment.

FIG. 16 is a cross-sectional view showing a small freezing chamber door and a second partition wall of the refrigerator of the first modified example of the seventh embodiment.

FIG. 17 is a cross-sectional view showing a small freezing chamber door and a second partition wall of a refrigerator of a second modified example of the seventh embodiment.

### DESCRIPTION OF EMBODIMENTS

Hereinafter, refrigerators of embodiments will be described with reference to the drawings. In the description below, configurations having the same or similar functions are designated by the same reference numerals. Redundant description of these configurations may be omitted. In the specification, the left and right sides are defined based on a direction in which a user standing in front of the refrigerator sees the refrigerator. In the refrigerator, the side closer to the user standing in front of the refrigerator is defined as the “front side” and the side far from the user is defined as the “rear side”. In the specification, the “width direction” means the left and right direction in the above definition. In the specification, the “depth direction” means the front and rear direction in the above definition. In the present specification, “ZZ is sandwiched between XX and YY” is not limited to a case in which ZZ is in contact with XX and YY, and also includes a case in which another member is interposed in at least one of a space between ZZ and XX and a space between ZZ and YY.

### First Embodiment

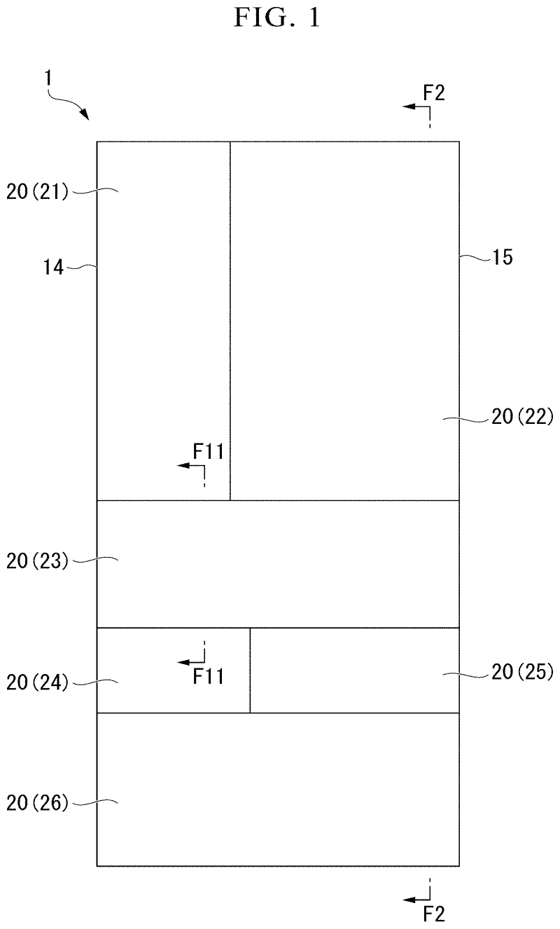

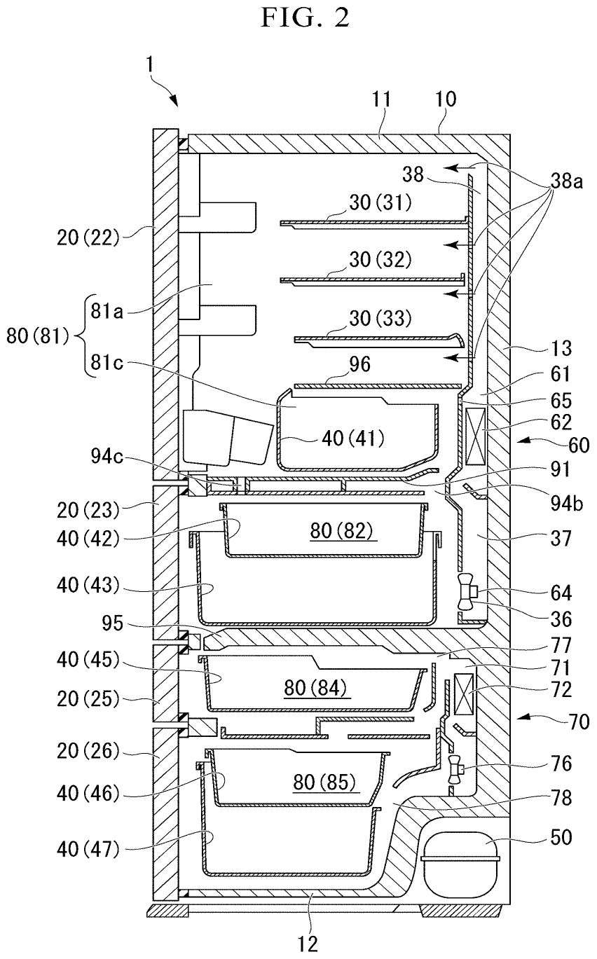

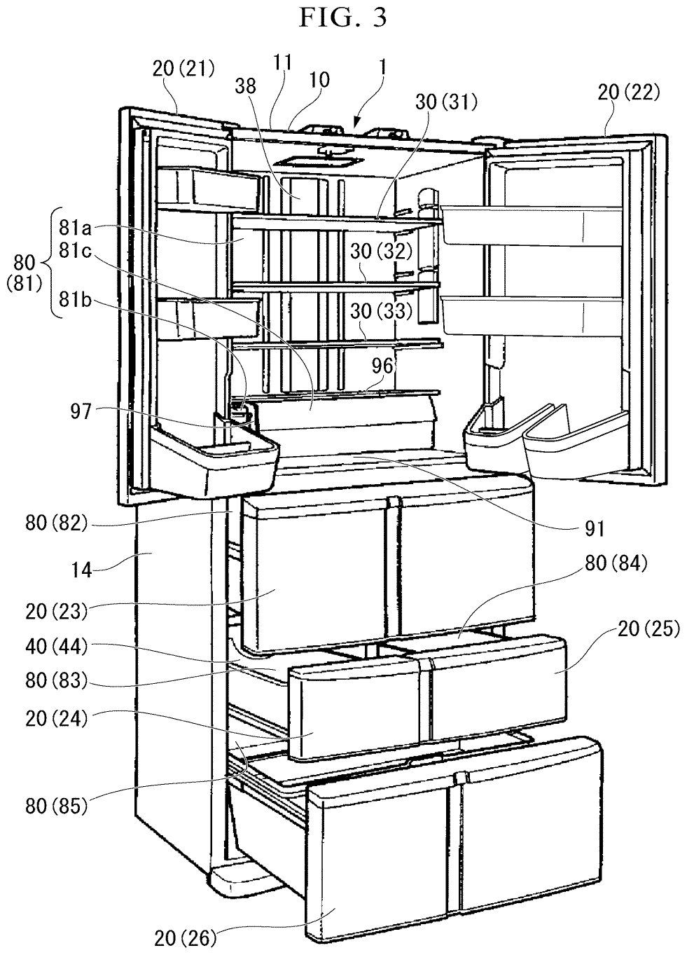

FIG. 1 is a front view showing a refrigerator 1 of a first embodiment. FIG. 2 is a cross-sectional view along line F2-F2 of FIG. 1. FIG. 3 is a perspective view showing a schematic configuration of the refrigerator 1 of the first embodiment. In FIG. 2, for convenience of explanation, illustrations of a partition wall heat-insulating sheet 301 to be described later will be omitted.

The refrigerator 1 includes, for example, a housing 10, a plurality of doors 20 (21 to 26), a plurality of shelves 30 (31 to 33), a plurality of containers 40 (41 to 47), a compressor 50, a first cooling mechanism 60, and a second cooling mechanism 70.

The housing 10 includes, for example, an outer box, an inner box, and a heat-insulating material filled between the outer box and the inner box and has heat-insulating properties. The heat-insulating material is a foamed heat-insulating material such as urethane foam. The housing 10 includes a ceiling wall 11, a bottom wall 12, a rear wall 13, a left wall 14, and a right wall 15.

A plurality of storage chambers 80 are provided inside the housing 10. The plurality of storage chambers 80 include, for example, a refrigerating chamber 81, a vegetable chamber 82, an ice-making chamber 83 (see FIG. 3), a small freezing chamber 84, and a main freezing chamber 85. In the first embodiment, the refrigerating chamber 81 is disposed at the uppermost portion, the vegetable chamber 82 is disposed below the refrigerating chamber 81, the ice-making chamber 83 and the small freezing chamber 84 are disposed below the vegetable chamber 82, and the main freezing chamber 85 is disposed below the ice-making chamber 83 and the small freezing chamber 84. The arrangement of the storage chamber 80 is not limited to the above-described example. As the arrangement of the storage chamber 80, for example, the arrangement of the vegetable chamber 82 and the main freezing chamber 85 may be reversed. In the housing 10, an opening is formed on a front surface side of each storage chamber 80 so that food is allowed to be taken in and out of each storage chamber 80. The refrigerating chamber 81 is an example of a “first storage chamber.” The vegetable chamber 82 is an example of a “second storage chamber.” The ice-making chamber 83 is an example of a “third storage chamber.”

The plurality of doors 20 (21 to 26) include a left refrigerating chamber door 21, a right refrigerating chamber door 22, a vegetable chamber door 23, an ice-making chamber door 24, a small freezing chamber door 25, and a main freezing chamber door 26. The left refrigerating chamber door 21 and the right refrigerating chamber door 22 close the refrigerating chamber 81 so as to be openable. The vegetable chamber door 23 closes the vegetable chamber 82 so as to be openable. The ice-making chamber door 24 closes the ice-making chamber 83 so as to be openable. The small freezing chamber door 25 closes the small freezing chamber 84 so as to be openable. The main freezing chamber door 26 closes the main freezing chamber 85 so as to be openable.

The housing 10 includes a partition wall 91 and a partition wall 95. The partition wall 91 is a partition wall which is provided in a substantially horizontal direction. The partition wall 91 is provided between the refrigerating chamber 81 and the vegetable chamber 82 and partitions the refrigerating chamber 81 from the vegetable chamber 82. For example, the partition wall 91 forms a bottom wall of the refrigerating chamber 81 and forms a ceiling wall of the vegetable chamber 82. The bottom wall of the refrigerating chamber 81 includes bottom walls of an ice-making water supply tank chamber 81b and a chilled chamber 81c which will be described later.

The partition wall 95 is a heat-insulating partition wall which is provided in a substantially horizontal direction. The partition wall 95 is provided between the vegetable chamber 82, and the ice-making chamber 83 and the small freezing chamber 84. The partition wall 95 partitions the vegetable chamber 82 from the ice-making chamber 83 and the small freezing chamber 84. For example, the partition wall 95 forms a bottom wall of the vegetable chamber 82 and forms a ceiling wall of the ice-making chamber 83 and the small freezing chamber 84. The partition wall 91 is an example of a “second partition portion.”

The partition wall 91 includes one or more front vents 94c on the front side of the depth direction. The front vent 94c is a through-hole penetrating the partition wall 91. The refrigerating chamber 81 and the vegetable chamber 82 communicate with each other by the front vent 94c. One or more corners on the inner side of the partition wall 91 in the depth direction are formed in a notch shape to form a rear vent 94b. The rear vent 94b is a through-hole penetrating the partition wall 91. The refrigerating chamber 81 and the vegetable chamber 82 communicate with each other by the rear vent 94b. The partition wall 91 may include at least one of the front vent 94c and the rear vent 94b.

The refrigerating chamber 81 is provided with a normal refrigerating chamber 81a, an ice-making water supply tank chamber 81b, and a chilled chamber 81c. The ice-making water supply tank chamber 81b and the chilled chamber 81c are provided at the lowermost portion inside the refrigerating chamber 81 (the upper portion of the partition wall 91). For example, the ice-making water supply tank chamber 81b is located on the left side and the chilled chamber 81c is located on the right side when viewed from the user.

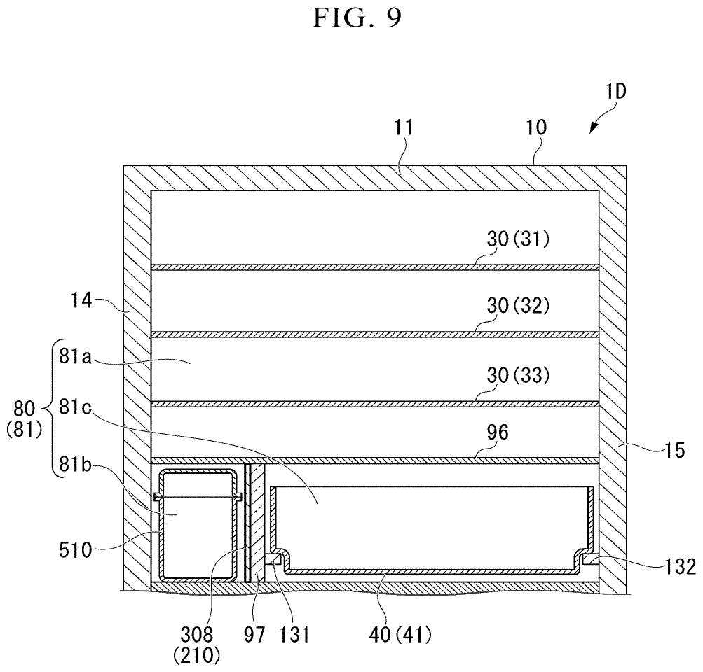

A chilled chamber upper surface partition portion 96 which is provided in a substantially horizontal direction partitions the normal refrigerating chamber 81a and the chilled chamber 81c and partitions the normal refrigerating chamber 81a and the ice-making water supply tank chamber 81b. An ice-making water supply tank chamber partition wall 97 which is provided in a substantially vertical direction (see FIGS. 3 and 9) partitions the ice-making water supply tank chamber 81b and the chilled chamber 81c. The chilled chamber 81c is provided below at least a part of the normal refrigerating chamber 81a. The normal refrigerating chamber 81a is an example of a “first storage portion”. The chilled chamber 81c is an example of a “second storage portion”. The chilled chamber upper surface partition portion 96 is an example of elements constituting a “first partition portion”. The ice-making water supply tank chamber partition wall 97 is an example of elements constituting the “first partition portion”.

The normal refrigerating chamber 81a, the ice-making water supply tank chamber 81b, and the vegetable chamber 82 are all kept in a refrigeration temperature zone (for example, 1 to 5° C.). The refrigeration temperature zone (for example, 1 to 5° C.) is, for example, an example of a temperature of the first storage portion. On the other hand, the chilled chamber 81c is kept in a chilled temperature zone (for example, 0 to 1° C.). The chilled temperature zone (for example, 0 to 1° C.) is, for example, an example of a temperature of the second storage portion that is cooled to a temperature zone lower than that of the first storage portion. That is, the second storage portion (the chilled chamber 81c) is cooled to a temperature zone lower than that of the first storage portion (the normal refrigerating chamber 81a, the ice-making water supply tank chamber 81b, and the vegetable chamber 82).

The plurality of shelves 30 are provided in the refrigerating chamber 81. The plurality of containers 40 include a chilled case 41, a first 42, a second vegetable chamber container 43, an ice-making chamber container 44, a small freezing chamber container 45, a first main freezing chamber container 46, and a second main freezing chamber container 47. The chilled case 41 is provided in the chilled chamber 81c of the refrigerating chamber 81. The first vegetable chamber container 42 and the second vegetable chamber container 43 are provided in the vegetable chamber 82. The ice-making chamber container 44 (see FIG. 3) is provided in the ice-making chamber 83. The small freezing chamber container 45 is provided in the small freezing chamber 84. The first main freezing chamber container 46 and the second main freezing chamber container 47 are provided in the main freezing chamber 85.

The compressor 50 is provided, for example, in a machine room at a bottom portion of the refrigerator 1. The compressor 50 compresses a refrigerant gas used for cooling the storage chamber 80. The refrigerant gas compressed by the compressor 50 is sent to coolers 62 and 72 via a heat dissipation pipe (not illustrated) or the like.

The first cooling mechanism 60 (the cooling mechanism of the refrigerating temperature zone) includes, for example, a blower duct 37, a cold air supply duct 38, a refrigerating cooler chamber 61, a refrigerating cooler 62, a refrigerating blower fan 64, and a chilling cold air supply port 65. The refrigerating blower fan 64 is disposed behind the vegetable chamber 82 along with the refrigerating chamber suction port 36 and the blower duct 37. The refrigerating blower fan 64 blows air to the refrigerating cooler 62. In the specification, “blowing air to the cooler” is not limited to a case in which a blower fan is disposed on the upstream side of the cooler in the air flow direction and blows air toward the cooler. In the specification, “blowing air toward the cooler” also includes a case in which a blower fan is disposed on the downstream side of the cooler in the air flow direction and ambient air is further fed to the downstream side so that air located on the upstream side of the cooler is moved toward the cooler. The blower duct 37 communicates with the refrigerating cooler chamber 61. The refrigerating chamber suction port 36 opens to, for example, the vegetable chamber 82.

In this configuration, when the refrigerating blower fan 64 is driven, air inside the vegetable chamber 82 is sucked from the refrigerating chamber suction port 36 toward the refrigerating blower fan 64 and the sucked air is blown out toward the blower duct 37. Air blown out toward the blower duct 37 contacts the refrigerating cooler chamber 61 to be cooled by exchanging heat. The cooled air (cold air) passes through the cold air supply duct 38 and is blown out from a plurality of refrigerating cold air supply ports 38a to the normal refrigerating chamber 81a. The cooled air (cold air) is ejected from the chilling cold air supply port 65 to the chilled chamber 81c. The cold air flowing into the normal refrigerating chamber 81a and the chilled chamber 81c flows to the vegetable chamber 82 through the front vent 94c and the rear vent 94b and is finally suctioned to the refrigerating blower fan 64 and circulated.

In this circulation process, air passing through the refrigerating cooler chamber 61 is cooled by the refrigerating cooler 62 to become cold air and the cold air is supplied to the normal refrigerating chamber 81a so that the normal refrigerating chamber 81a is cooled to a temperature in the refrigerating temperature zone. The cold air is supplied to the chilled chamber 81c so that the chilled chamber 81c is cooled to a temperature in the chilled temperature zone. Since the chilled chamber 81c is located at a position closer to the refrigerating cooler chamber 61 in relation to the normal refrigerating chamber 81a or the vegetable chamber 82, the chilled chamber 81c is kept in a chilled temperature zone (for example, 0 to 1° C.) which is lower than the refrigerating temperature zone (for example, 1 to 5° C.).

The second cooling mechanism 70 (the cooling mechanism of the refrigerating temperature zone) includes, for example, a freezing cooler chamber 71, a freezing cooler 72, and a freezing blower fan 76. The freezing cooler chamber 71 is provided on the back wall portion of the storage chamber (the ice-making chamber 83, the small freezing chamber 84, and the main freezing chamber 85) in the refrigerating temperature zone of the refrigerator 1. The freezing cooler 72 or a defrosting heater (not shown) is disposed in the freezing cooler chamber 71. The freezing blower fan 76 is disposed below the freezing cooler 72. A cold air outlet 77 is provided at the upper end portion of the front surface of the freezing cooler chamber 71. A freezing chamber suction port 78 is provided at the lower end portion of the front surface of the freezing cooler chamber 71.

When the freezing blower fan 76 is driven, cold air generated by the freezing cooler 72 is supplied from the cold air outlet 77 into the ice-making chamber 83, the small freezing chamber 84, and the main freezing chamber 85 and is returned from the freezing chamber suction port 78 into the freezing cooler chamber 71 and circulated. Accordingly, the ice-making chamber 83, the small freezing chamber 84, and the main freezing chamber 85 are cooled.

Next, a heat-insulation structure of the first embodiment will be described in detail.

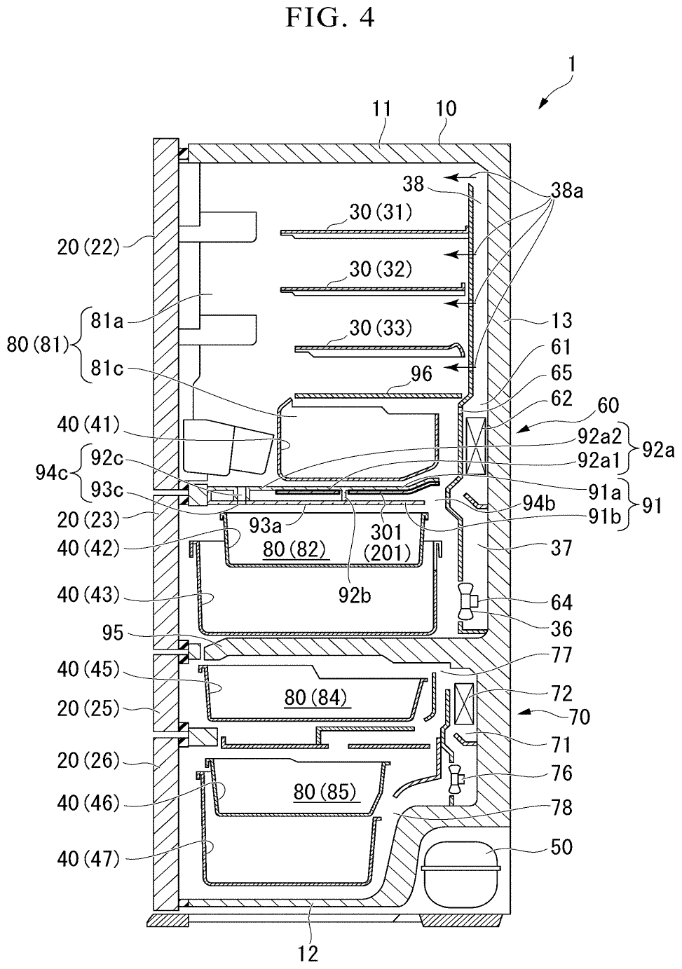

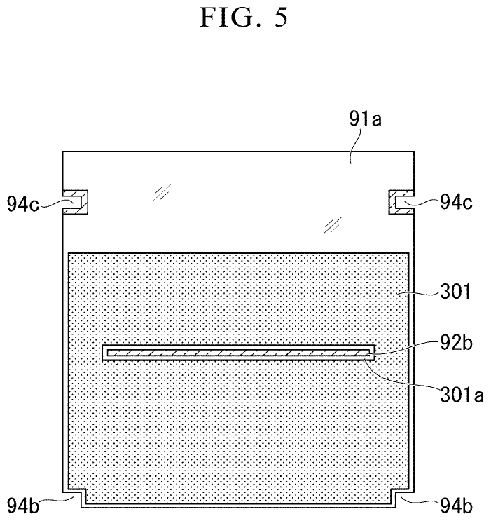

FIG. 4 is a cross-sectional view showing the refrigerator 1 of the first embodiment. FIG. 5 is a bottom view of a partition wall upper member 91a of the partition wall 91 of the first embodiment from below. As illustrated, the partition wall 91 includes, for example, the partition wall upper member 91a, a partition wall lower member 91b, and the partition wall heat-insulating sheet 301. The partition wall 91 is an example of both a “partition portion” and the “second partition portion.”

The partition wall upper member 91a is formed of a material having lower heat insulation (higher thermal conductivity) than the partition wall heat-insulating sheet 301 to be described later. The material having lower heat insulation than the partition wall heat-insulating sheet 301 is, for example, a general synthetic resin. The partition wall upper member 91a includes a plate portion 92a, a rib 92b, and one or more cold air guide portions 92c. The plate portion 92a extends horizontally and forms a partition wall between the normal refrigerating chamber 81a and the chilled chamber 81c. For example, the plate portion 92a forms a bottom wall of the refrigerating chamber 81. The bottom wall of the refrigerating chamber 81 includes bottom walls of the ice-making water supply tank chamber 81b and the chilled chamber 81c.

The plate portion 92a has a first region 92a1 which is located below the chilled chamber 81c and a second region 92a2 which is located outside the lower portion of the chilled chamber 81c. The second region 92a2 is located on the front side of, for example, the chilled chamber 81c. That is, the second region 92a2 is positioned on a front side of the first region 92a1 in the depth direction of the refrigerator 1. The first region 92a1 forms the bottom wall of the chilled chamber 81c. The second region 92a2 forms the bottom wall of the normal refrigerating chamber 81a, for example, on the front side of the chilled chamber 81c.

The rib 92b is, for example, a plate-shaped protrusion portion which extends in the width direction of the refrigerator 1 and protrudes downward from the lower surface of the plate portion 92a. For example, a lower end portion of the rib 92b is comes into contact with the upper surface of the first partition wall lower member 91Db. In the present embodiment, the rib 92b is provided in the first region 92a1 of the plate portion 92a.

The cold air guide portions 92c, for example, protrude downward from the plate portion 92a and comes in contact with the upper surface of the partition wall lower member 91b. The cold air guide portions 92c have through holes through which the cold air flows. As illustrated in FIG. 4, in the first embodiment, the cold air guide portions 92c are notches in which the through holes through which the cold air flows between them and side portions of the refrigerator 1 are formed.

The partition wall lower member 91b is formed of a material having lower heat insulation than the partition wall heat-insulating sheet 301 to be described later. The material having lower heat insulation than the partition wall heat-insulating sheet 301 is, for example, a general synthetic resin. The partition wall lower member 91b includes a plate portion 93a and one or more cold air guide portions 93c. The plate portion 93a extends horizontally and forms the ceiling wall of the vegetable chamber 82. The plate portion 93a is located below the partition wall upper member 91a, and a space exists between the plate portion and the partition wall upper member 91a.

The cold air guide portion 93c is provided at a position corresponding to the cold air guide portion 92c. The cold air guide portion 93c includes a through-hole through which cold air flows. In the first embodiment, the cold air guide portion 93c is a notch portion which forms a through-hole through which the cold air flows between them and the side portions of the refrigerator 1.

Each of the partition wall upper member 91a and the partition wall lower member 91b is a thin plate-shaped member that is formed of, for example, a member such as a synthetic resin.

The partition wall heat-insulating sheet 301 is formed of, for example, a heat-insulating material 210 (hereinafter referred to as “specific heat-insulating material 210” for convenience of explanation) to be described later. The partition wall heat-insulating sheet 301 is adhered to a lower surface of the first region 92a1 of the plate portion 92a of the partition wall upper member 91a with an adhesive or a double-sided tape. In the present embodiment, the partition wall heat-insulating sheet 301 is not provided in the second region 92a2 of the plate portion 92a of the partition wall upper member 91a. The first region 92a1 of the plate portion 92a of the partition wall upper member 91a, the partition wall heat-insulating sheet 301, and a portion of the partition wall lower member 91b corresponding to the first region 92a1 configure an example of a “first region positioned on a lower side of the second storage portion.” The second region 92a2 of the plate portion 92a of the partition wall upper member 91a configures an example of a “second region positioned on a front side of the first region”.

The specific heat-insulating material 210 is a heat-insulating material containing an aerogel, a xerogel, or a cryogels. “Containing an aerogel, a xerogel, or a cryogel” is used to mean “containing one or more of the aerogel, the xerogel, or the cryogel.” An aerogel, a xerogel, and a cryogel are each a low-density structure (dried gel). The “aerogel” is, for example, a porous substance in which a solvent contained in the gel is substituted with a gas by supercritical drying. The “xerogel” is a porous substance in which a solvent contained in the gel is substituted with a gas by evaporation drying. The “cryogel” is a porous substance in which a solvent contained in the gel is substituted with a gas by freeze drying.

There are some aerogels that can be dried without using supercritical drying, for example, by introducing a specific element. The term “aerogel” as used in the present specification also includes such aerogels. That is, the term “aerogel” as used in the present specification is not limited to those manufactured by using supercritical drying, and broadly refers to materials of various types distributed as “aerogels.” As such an aerogel that does not require supercritical drying, for example, an organic-inorganic hybrid aerogel in which an organic chain such as a methyl group is introduced into a molecular network of silicon dioxide is known, including PMSQ (CH₃SiO_{1.5}) aerogel and the like. However, these are merely examples.

An aerogel, a xerogel, and a cryogel are each an ultra-low density dry porous body having a large number of fine pores (voids) and an extremely high porosity (porosity of 90% or more, and preferably 95% or more). A density of the dry porous body is, for example, 150 mg/cm³ or less. Each of the aerogel, the xerogel, and the cryogel has, for example, a structure in which silicon dioxide and the like are bonded in a ball chain shape and has a large number of voids at a nanometer level (for example, 100 nm or less, and preferably 2 nm to 50 nm). Since the aerogel, the xerogel, and the cryogel each have nanometer-level pores and a lattice-shaped structure, a mean free path of gas molecules can be reduced, thermal conduction between gas molecules is very small even at normal pressure, and thermal conductivity is very small. For example, the aerogel, the xerogel, and the cryogel each have fine voids that are smaller than a mean free path of air.

As aerogel, xerogel, and cryogel, inorganic aerogel, inorganic xerogel, or inorganic cryogel made of metal oxides such as silicon, aluminum, iron, copper, zirconium, hafnium, magnesium, and yttrium may be used, and for example, silica aerogel, silica xerogel, or silica cryogel containing silicon dioxide may be used. These have a structure in which silica (SiO₂) fine particles having a diameter of 10 nm to 20 nm are connected and have pores having a width of tens of nanometers. Since aerogel, xerogel, and cryogel have low density, the heat conduction in solid parts is extremely low. Further, since the movement of air inside the pores is restricted, aerogel, xerogel, and cryogel have extremely low thermal conductivity (0.012 to 0.02 W/m·K). Since silica fine particles and pores are smaller than a wavelength of visible light and thus do not scatter visible light, light transmittance is high. As a material of the aerogel, xerogel, or cryogel of the specific heat-insulating material 210, a material having light transmission (for example, a transparent material) may be employed, or a material having no light transmittance may be employed. The material forming aerogel, xerogel, and cryogel may be carbon or the like.

Airgel, xerogel, and cryogel can have arbitrary properties (for example, elasticity and flexibility) by selecting the material. High elasticity or flexibility can be imparted by selecting, for example, polypropylene as the material for aerogel, xerogel, and cryogel.

Each of aerogel, xerogel, and cryogel may form the specific heat-insulating material 210. Alternatively, each of aerogel, xerogel, and cryogel may form the specific heat-insulating material 210 which is a composite heat-insulating material by immersing another material (for example, a fiber structure) in the state of a precursor. Such a fiber structure is a reinforcing material for reinforcing a dry gel or a member acting as a support for supporting a dry gel. As the fiber structure, a flexible woven fabric, knitted fabric, non-woven fabric, and the like are used to obtain a flexible composite heat-insulating material. As the fiber structure, a felt or blanket-like structure is more preferably used. As the material of the fiber structure, inorganic fibers such as glass fibers can also be used in addition to organic fibers such as polyester fibers.

The fiber structure is, for example, a natural polymer chitosan. The specific heat-insulating material 210 contains a three-dimensional network structure of hydrophobicized fine chitosan fibers and has an ultra-high porosity (96 to 97% of the volume is void). Hydrophobization enhances the moisture resistance which is a problem with materials made of polysaccharide nanofibers and has water repellency while maintaining the homogeneous nanostructure of hydrophilic chitosan aerogel.

The specific heat-insulating material 210 may be, for example, a heat-insulating material in which a polypropylene foam and one selected from silica aerogel, xerogel, and cryogel are composited.

The thermal conductivity of the specific heat-insulating material 210 is higher than the thermal conductivity of the vacuum heat-insulating material, but is lower than the thermal conductivity of the foamed heat-insulating material such as urethane foam. That is, the heat-insulating property of the specific heat-insulating material 210 is not as good as that of the vacuum heat-insulating material, but is superior to the heat-insulating property of the foamed heat-insulating material. The thermal conductivity of the specific heat-insulating material 210 is, for example, 0.010 W/m·K to 0.015 W/m·K. The thermal conductivity of the vacuum heat-insulating material is, for example, 0.003 W/m·K to 0.005 W/m·K. The thermal conductivity of the foamed heat-insulating material is, for example, 0.020 W/m·K to 0.022 W/m·K. These numerical values are merely examples.

When the specific heat-insulating material 210 has flexibility, the flexibility (bendability) of the specific heat-insulating material 210 is, for example, higher than the flexibility of the vacuum heat-insulating material and is higher than the flexibility of the foamed heat-insulating material. When the specific heat-insulating material 210 has elasticity, the elasticity of the specific heat-insulating material 210 is, for example, higher than the elasticity (substantially close to zero) of the vacuum heat-insulating material and is higher than the elasticity (substantially close to zero) of the foamed heat-insulating material.

The partition wall heat-insulating sheet 301 is formed in a sheet shape and has, for example, flexibility (flexibility). The partition wall heat-insulating sheet 301 is deformed according to a shape of a lower surface of the partition wall upper member 91a and attached to the lower surface of the partition wall upper member 91a. For example, as shown in FIG. 5, the partition wall heat-insulating sheet 301 includes a hole portion 301a which is elongated in the width direction and corresponds to the rib 92b. In a state in which the partition wall heat-insulating sheet 301 is adhered to the lower surface of the partition wall upper member 91a, the rib 92b penetrates the hole portion 301a downward. The partition wall upper member 91a allowing the partition wall heat-insulating sheet 301 to be adhered to the lower surface thereof is superimposed on the partition wall lower member 91b and both engage with each other by engagement means (not shown) to form the partition wall 91.

As described above, the front vent 94c is formed by a pair of cold air guide portions 92c and 93c. The front vent 94c is a notch penetrating the partition wall upper member 91a and the partition wall lower member 91b. The refrigerating chamber 81 communicates with the vegetable chamber 82 through the front vents 94c. Similarly, one or more corners on the inner side of the partition wall 91 in the depth direction are formed in a notch shape to form the rear vent 94b. The rear vent 94b is a notch penetrating the partition wall upper member 91a and the partition wall lower member 91b. The refrigerating chamber 81 communicates with the vegetable chamber 82 through the rear vents 94b. The partition wall 91 may include at least one or more of the front vent 94c and the rear vent 94b.

According to the refrigerator 1 of the first embodiment, the partition wall heat-insulating sheet 301 is provided right below the chilled chamber 81c (the first region 92a1 of the plate portion 92a). Therefore, a temperature of the chilled chamber 81c kept in the chilled temperature zone (for example, 0 to 1° C.), which is a lower temperature than that of the refrigeration temperature zone (for example, 1 to 5° C.), is inhibited from being transmitted to the vegetable chamber 82. That is, according to the refrigerator 1 of the first embodiment, occurrence of a locally overcooled portion in the vegetable chamber 82 due to the temperature of the chilled chamber 81c is capable of being inhibited. When the temperature of the chilled chamber 81c is not easily transmitted to the vegetable chamber 82, dew condensation does not easily occur on the ceiling wall of the vegetable chamber 82.

The partition wall heat-insulating sheet 301 is not provided in the second region 92a2 of the plate portion 92a. Therefore, since the vegetable chamber 82 can be efficiently cooled by the temperature of the normal refrigerating chamber 81a, it is possible to improve energy saving performance of the refrigerator 1.

The partition wall heat-insulating sheet 301 may be attached to an upper surface of the partition wall upper member 91a, may be attached to the upper surface of the partition wall lower member 91b, and may be attached to a lower surface of the partition wall lower member 91b instead of being attached to the lower surface of the partition wall upper member 91a.

### Modified Example of First Embodiment

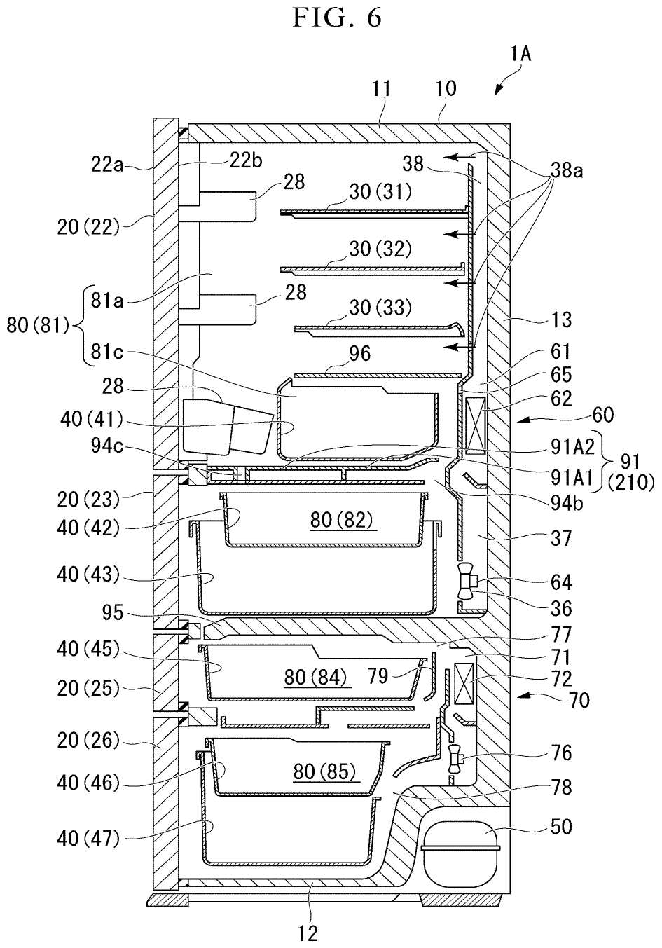

FIG. 6 is a cross-sectional view showing a refrigerator 1A of a modified example of the first embodiment. The refrigerator 1A of the first modified example of the first embodiment has the same configuration as that of the refrigerator 1 of the first embodiment, but is different from the refrigerator 1 of the first embodiment in that a partition wall 91A is provided instead of the partition wall 91.

The partition wall 91A includes a first region 91A1 which is located below the chilled chamber 81c and a second region 91A2 which is located outside from the lower side of the chilled chamber 81c. The second region 91A2 is located, for example, on a front side of the chilled chamber 81c. That is, the second region 91A2 is positioned on a front side with respect to the first region 91A1 in the depth direction of the refrigerator 1A. In the first modified example of the first embodiment, both the first region 91A1 and the second region 91A2 are formed of the specific heat-insulating material 210.

Accordingly, the partition wall 91A has a heat-insulating property even if the partition wall heat-insulating sheet 301 is not attached to the partition wall. The partition wall 91A is an example of the “partition portion”.

According to the refrigerator 1A of the modified example of the first embodiment, it is possible to obtain the same effects (insulation from the chilled chamber 81c and inhibition of dew condensation) as the refrigerator 1 of the first embodiment described above. In addition, according to the refrigerator 1A of the modified example of the first embodiment, it is possible to simplify the structure of the partition wall 91A and simplify the manufacturing process.

In the partition wall 91A, only the first region 91A1 may be formed of the specific heat-insulating material 210, and the second region 91A2 may be formed of a synthetic resin or the like. In this case, since the vegetable chamber 82 can be efficiently cooled by the temperature of the normal refrigerating chamber 81a through the second region 91A2, energy saving performance of the refrigerator 1A can be improved.

### Second Embodiment

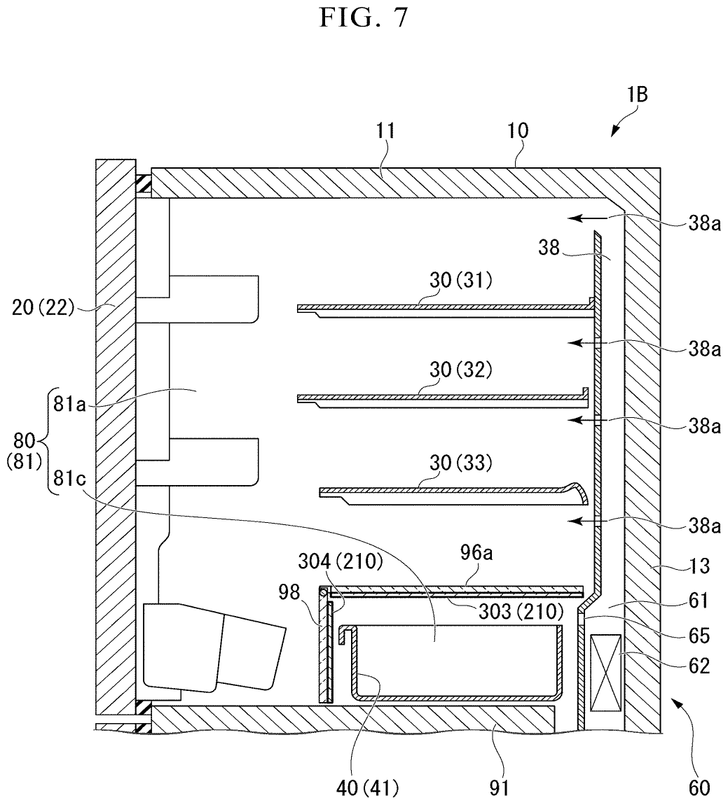

FIG. 7 is a cross-sectional view showing a refrigerator 1B of a second embodiment. The refrigerator 1B of the second embodiment is configured similarly to the refrigerator 1 of the first embodiment, but the refrigerator 1B of the second embodiment is different from the refrigerator 1 of the first embodiment in that a chilled chamber upper surface partition portion 96a is provided instead of the chilled chamber upper surface partition portion 96 and a chilled chamber lid 98 is provided. In the present embodiment, an example of a “first partition portion” that partitions the inside of a refrigerating chamber 81 into at least a normal refrigerating chamber 81a and a chilled chamber 81c is configured by the chilled chamber upper surface partition portion 96a, the chilled chamber lid 98, and insulating sheets 303 and 304 attached thereto.

The refrigerator 1B of the second embodiment includes a chilled case 41, the chilled chamber upper surface partition portion 96a, the chilled chamber lid 98, the partition wall heat-insulating sheet 303, and the partition wall heat-insulating sheet 304.

The chilled chamber upper surface partition portion 96a extends in a substantially horizontal direction between the normal refrigerating chamber 81a and the chilled chamber 81c and forms a ceiling wall (ceiling portion) of the chilled chamber 81c. The chilled chamber lid 98 is located on a front side of the chilled chamber 81c. The chilled chamber lid 98 covers the chilled chamber 81c so as to openable and closable by, for example, being connected to a front upper end portion of the chilled chamber upper surface partition portion 96a so as to be openable and closable.

The chilled chamber 81c is partitioned from the normal refrigerating chamber 81a by the chilled chamber upper surface partition portion 96a and the chilled chamber lid 98. The chilled case 41 provided to allow foodstuffs to be taken in and out is provided inside the chilled chamber 81c.

The chilled chamber upper surface partition portion 96a and the chilled chamber lid 98 are formed of, for example, a member such as a synthetic resin. The partition wall heat-insulating sheet 303 is formed of, for example, a specific heat-insulating material 210 and is adhered to a lower surface of the chilled chamber upper surface partition portion 96a with an adhesive or a double-sided tape.

Similarly, the partition wall heat-insulating sheet 304 is formed of, for example, the specific heat-insulating material 210. The partition wall heat-insulating sheet 304 is adhered to an inner surface of the chilled chamber lid 98 (a surface exposed inside the chilled chamber 81c) with an adhesive or a double-sided tape.

In the present embodiment, an example of the “first partition portion” that partitions the inside of the refrigerating chamber 81 into at least the normal refrigerating chamber 81a and the chilled chamber 81c is configured by the chilled chamber upper surface partition portion 96a, the chilled chamber lid 98, the partition wall heat-insulating sheet 303, and the partition wall heat-insulating sheet 304. An example of “a ceiling plate portion positioned between a first storage portion and a second storage portion and forming a ceiling portion of the second storage portion” is configured by the partition wall heat-insulating sheet 303 and the chilled chamber upper surface partition portion 96a. The partition wall heat-insulating sheet 304 and the chilled chamber lid 98 configure an example of “a lid positioned on a front side of the second storage portion and covering the second storage portion such that it can be opened and closed”.

The chilled chamber upper surface partition portion 96a and the chilled chamber lid 98 may be formed of the specific heat-insulating material 210. In this case, the chilled chamber upper surface partition portion 96a is an example of the “ceiling plate portion”, and the entire thickness of the “ceiling plate portion” is formed by the specific heat-insulating material 210. With this configuration, the chilled chamber upper surface partition portion 96a and the chilled chamber lid 98 have heat-insulating properties without adhering the partition wall heat-insulating sheet 303 and the partition wall heat-insulating sheet 304. With this configuration, the chilled chamber upper surface partition portion 96a and the chilled chamber lid 98 can have a simple structure and the manufacturing process can be simplified in addition to the above-described effect.

### Third Embodiment

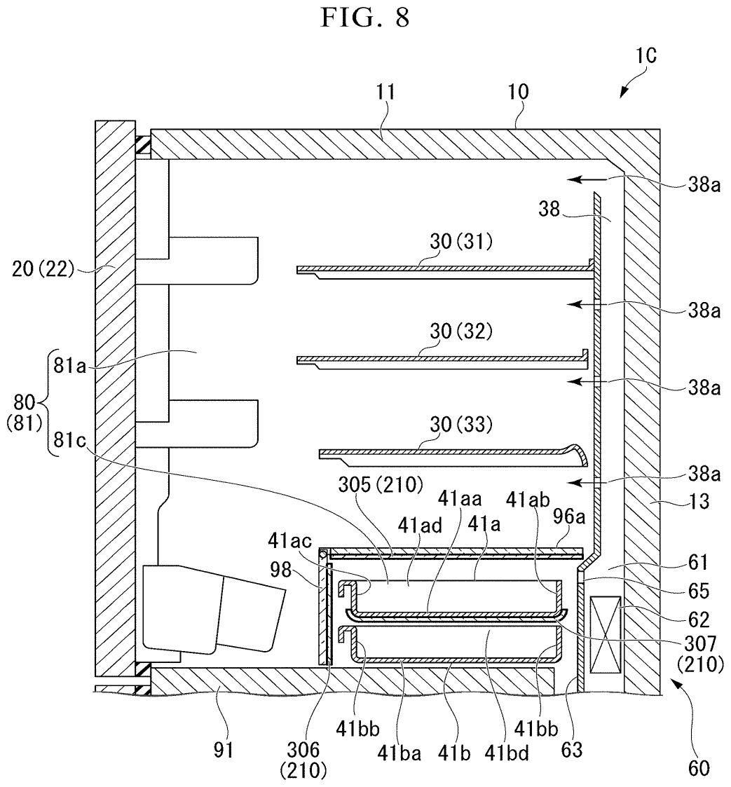

FIG. 8 is a cross-sectional view showing a refrigerator 1C of a third embodiment. The refrigerator 1C of the third embodiment is different from the refrigerator 1B of the second embodiment in that a two-stage tray (chilled cases) is provided in a chilled chamber 81c and a chilled cold air supply port 65 is provided at a front wall part 63 of a refrigeration cooler chamber 61 (rear wall part of the chilled chamber 81c).

The refrigerator 1C of the third embodiment includes an upper chilled case 41a, a lower chilled case 41b, a chilled chamber upper surface partition portion 96a, a chilled chamber lid 98, a partition wall heat-insulating sheet 305, a partition wall heat-insulating sheet 306, and a partition wall heat-insulating sheet 307. The chilled chamber 81c is partitioned from a normal refrigerator chamber 81a by the chilled chamber upper surface partition portion 96a and the chilled chamber lid 98.

The upper chilled case 41a and the lower chilled case 41b provided to allow foodstuffs to be put in and taken out are provided inside the chilled chamber 81c. The upper chilled case 41a is disposed on an upper side of the lower chilled case 41b. At least, the chilled chamber upper surface partition portion 96a, the chilled chamber lid 98, and the upper chilled case 41a are formed of, for example, a member such as a synthetic resin. The lower chilled case 41b is also formed of, for example, a member such as a synthetic resin.

The partition wall heat-insulating sheet 305, the partition wall heat-insulating sheet 306, and the partition wall heat-insulating sheet 307 are formed of, for example, a specific heat-insulating material 210. The partition wall heat-insulating sheet 305, the partition wall heat-insulating sheet 306, and the partition wall heat-insulating sheet 307 are each formed in a sheet shape and have flexibility. The partition wall heat-insulating sheet 305 is adhered to a lower surface of the chilled chamber upper surface partition portion 96a with an adhesive or a double-sided tape. The partition wall heat-insulating sheet 306 is adhered to a back surface of the chilled chamber lid 98 with an adhesive or a double-sided tape. The partition wall heat-insulating sheet 307 is adhered to a lower surface of a bottom portion of the upper chilled case 41a with an adhesive or a double-sided tape. For example, at least a part of the partition wall heat-insulating sheet 307 is deformed according to a curved surface portion of the bottom portion of the upper chilled case 41a and is attached to the curved surface portion of the bottom portion of the upper chilled case 41a.

In the present embodiment, an example of a “first tray” is configured by the lower chilled case 41b. An example of a “second tray” is configured by the upper chilled case 41a and the partition wall heat-insulating sheet 307. A bottom portion 41aa of the upper chilled case 41a and a portion attached to the bottom portion 41aa in the seventh partition wall heat-insulating sheet 307 constitute an example of the bottom portion of the second tray.

Specifically, the upper chilled case 41a includes, for example, the bottom portion 41aa, a rear wall 4 lab, a front wall 41ac, and left and right walls (only a left wall 41ad is shown) and is formed in a bowl shape to be opened upward. The bottom portion 41aa extends horizontally and is located between the inside (the storage space) of the upper chilled case 41a and the inside (the storage space) of the lower chilled case 41b. The rear wall 41ab stands upright from the rear end portion of the bottom portion 41aa. The rear wall 41ab is a wall portion which is closer to the chilling cold air supply port 65 than the bottom portion 41aa, the front wall 41ac, and the left and right walls. The front wall 41ac stands upright from the front end portion of the bottom portion 41aa. The left and right walls stand upright from the left and right end portions of the bottom portion 41aa.

The chilling cold air supply port 65 is provided in a front wall portion 63 of the refrigerating cooler chamber 61 (a rear wall portion of the chilled chamber 81c). In this embodiment, the chilling cold air supply port 65 is provided behind the upper chilled case 41a. For example, the chilling cold air supply port 65 is located on the side opposite to the lower chilled case 41b with respect to the bottom portion 41aa of the upper chilled case 41a in the up and down direction of the refrigerator 1.

The partition wall heat-insulating sheet 307 is adhered to, for example, the lower surface of the bottom portion 41aa and covers substantially the entire region of the bottom portion 41aa. A part of the rear wall 41ab (for example, a half or more including a region close to the chilled cold air supply port 65) is not covered with the partition wall heat-insulating sheet 307. Therefore, cold air supplied from the chilled cold air supply port 65 to the chilled chamber 81c can efficiently cool the inside of the upper chilled case 41a.

The partition wall heat-insulating sheet 307 may be attached to the rear wall 41ab and may cover substantially the entire region of the rear wall 41ab. In this case, since the cold air of the chilling cold air supply port 65 is difficult to be excessively transmitted to the upper chilled case 41a, it is possible to suppress the vicinity of the rear wall 41ab in the upper chilled case 41a from being locally overcooled.

As shown in the drawing, the cold air taken from the refrigerating blower fan 64 and cooled by the refrigerating cooler 62 is blown out from the chilling cold air supply port 65 to the vicinity of the upper chilled case 41a of the chilled chamber 81c at a first temperature. Part of the cold air having cooled the upper chilled case 41a cools the stored items such as food of the upper chilled case 41a and the temperature of the upper chilled case 41a rises by the heat exchange with the stored items. Then, the cold air flows along the chilled chamber lid 98, flows into the lower chilled case 41b at a second temperature higher than the first temperature, and cools the stored items of the lower chilled case 41b. Subsequently, the cold air is sucked by the refrigerating blower fan 64, passes behind the vegetable chamber 82, and returns from the refrigerating chamber suction port 36 to the refrigerating cooler 62.

According to the refrigerator 1C of the third embodiment, it is possible to obtain the same effects as that of the refrigerator 1B of the second embodiment described above. In addition, according to the refrigerator 1C of the third embodiment, it is possible to impart a temperature difference between the upper chilled case 41a and the lower chilled case 41b by increasing the heat-insulating property of the upper chilled case 41a. That is, the upper chilled case 41a can be kept at a temperature lower than that of the lower chilled case 41b. Accordingly, it is possible to properly use the upper chilled case 41a and the lower chilled case 41b depending on the type of food such that food such as meat and seafood easily damaged when stored in a thawing state is stored in the upper chilled case 41a and fresh food stored without freezing is stored in the lower chilled case 41b.

Similarly to the modified examples described above, the chilled chamber upper surface partition portion 96a, the chilled chamber lid 98, and the upper chilled case 41a may be formed of the specific heat-insulating material 210 instead of adhering the partition wall heat-insulating sheet 305, the partition wall heat-insulating sheet 306, and the partition wall heat-insulating sheet 307. In this case, it is possible to obtain the same effects as that of the refrigerators of each of the above-described modified examples in addition to the effects of the refrigerator 1H of the third embodiment.

The chilling cold air supply port 65 may be provided behind the lower chilled case 41b instead of being provided behind the upper chilled case 41a. In this case, the chilling cold air supply port 65 is located on the side opposite to the upper chilled case 41a with respect to the bottom portion 41aa of the upper chilled case 41a in the up and down direction of the refrigerator 1. In this case, the lower chilled case 41b can be kept at a temperature lower than that of the upper chilled case 41a.

### Fourth Embodiment

FIG. 9 is a cross-sectional view showing a refrigerator 1D of the fourth embodiment. The refrigerator 1D of the fourth embodiment is different from the refrigerator 1 of the first embodiment in that an ice-making water supply tank chamber partition wall 97 between an ice-making water supply tank chamber 81b and a chilled chamber 81c is formed of a member such as a synthetic resin and a partition wall heat-insulating sheet 308 is provided on a side of the ice-making water supply tank chamber 81b of the ice-making water supply tank chamber partition wall 97. The other configurations of the refrigerator 1D of the fourth embodiment are the same as those of the refrigerator 1 of the first embodiment. An example of a “side plate” disposed between an ice-making water supply tank 510 and the chilled chamber 81c is configured by the ice-making water supply tank chamber partition wall 97 and the partition wall heat-insulating sheet 308. An example of a “water storage container” in which water for ice-making is stored is configured by the ice-making water supply tank 510.

An inner surface of the ice-making water supply tank chamber partition wall 97 (a wall on a left side of a small freezing chamber 84) and an inner surface of a right wall 15 (a wall on a right side of the chilled chamber 81c) of a housing 10 include chilled chamber protruding parts 131 and 132. The chilled chamber protruding parts 131 and 132 are rails that guide movement of a chilled case 41 in a front-rear direction.

The partition wall heat-insulating sheet 308 is formed of, for example, a specific heat-insulating material 210. The partition wall heat-insulating sheet 308 is adhered to the ice-making water supply tank chamber partition wall 97 on the ice-making water supply tank chamber 81b side with an adhesive or a double-sided tape. The partition wall heat-insulating sheet 308 has a height extending over substantially the entire height of the ice-making water supply tank chamber partition wall 97 and has a length extending over substantially the entire length of the ice-making water supply tank chamber partition wall 97.

According to the refrigerator 1D of the fourth embodiment, water in the ice-making water supply tank 510 of the ice-making water supply tank chamber 81b can be inhibited from freezing by the cold air of the chilled chamber 81c. Therefore, according to the refrigerator 1D of the fourth embodiment, it is not necessary to provide a heater or the like under the ice-making water supply tank 510, and thus reduction in costs of the refrigerator 1D can be achieved.

The partition wall heat-insulating sheet 308 may be provided on a side of the ice-making water supply tank chamber partition wall 97 opposite to the ice-making water supply tank chamber 81b, that is, on a surface of the ice-making water supply tank chamber partition wall 97 facing the chilled chamber 81c. The partition wall heat-insulating sheet 308 may be provided on both the ice-making water supply tank chamber 81b side of the ice-making water supply tank chamber partition wall 97 and the side of the ice-making water supply tank chamber partition wall 97 opposite to the ice-making water supply tank chamber 81b.

The ice-making water supply tank chamber partition wall 97 may be formed of the specific heat-insulating material 210. In this case, the ice-making water supply tank chamber partition wall 97 has a heat-insulating property even when the eighth partition wall heat-insulating sheet 308 is not adhered. Thereby, the above-described effects can be obtained. In addition, a structure of the ice-making water supply tank chamber partition wall 97 can be simplified and a manufacturing process can be simplified.

### Fifth Embodiment

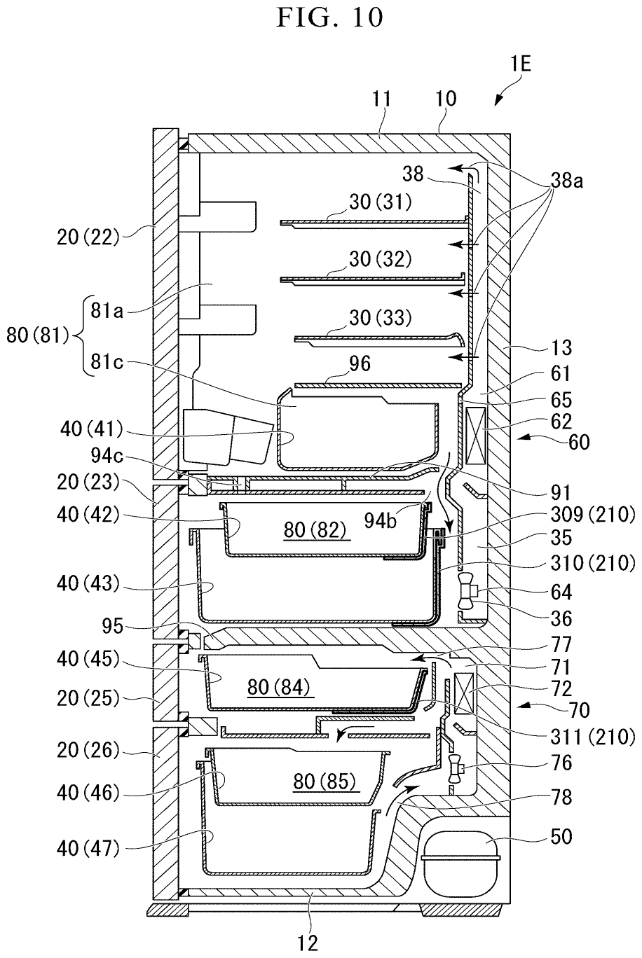

FIG. 10 is a cross-sectional view showing a refrigerator 1E of a fifth embodiment. The refrigerator 1E of the fifth embodiment is different from the refrigerator 1 of the first embodiment in that heat-insulating sheets 309, 310, and 311 are provided in portions on inner sides of containers to which cold air hits strongly. Other configurations of the refrigerator 1E are the same as those of the refrigerator 1 of the first embodiment.

The heat-insulating sheet 309, the heat-insulating sheet 310, and the heat-insulating sheet 311 are formed of a specific heat-insulating material 210. The heat-insulating sheet 309, the heat-insulating sheet 310, and the heat-insulating sheet 311 are formed in a sheet shape and have flexibility. A first vegetable chamber container 42, a second vegetable chamber container 43, and a small freezing chamber container 45 are formed of, for example, a member such as a synthetic resin.

The first vegetable chamber container 42, the second vegetable chamber container 43, and the small freezing chamber container 45 each have a bottom wall part, a front wall part, a left wall part, a right wall part, and a rear wall part. As illustrated in the figure, the heat-insulating sheet 309, the heat-insulating sheet 310, and the heat-insulating sheet 311 are each adhered to the rear wall part and a rear side of a center of the bottom wall part in the first vegetable chamber container 42, the second vegetable chamber container 43, and the small freezing chamber container 45, respectively, with an adhesive or a double-sided tape. Places to which the heat-insulating sheet 309, the heat-insulating sheet 310, and the heat-insulating sheet 311 are adhered are not particularly limited. It is preferable that the adhering position be a position exposed to strong cold air.

As described above, cold air flows from a refrigerator chamber 81 into a vegetable chamber 82 through a rear vent 94b of a partition wall 91. Therefore, the low-temperature cold air flows to a back surface portion of the first vegetable chamber container 42 and a back surface portion of the second vegetable chamber container 43. In these back surface portions, food is more likely to be exposed to a lower temperature than the position other than the back surface portions of the first vegetable chamber container 42 and the second vegetable chamber container 43. As described above, cold air generated by a freezing cooler 72 is supplied into a small freezing chamber 84 from a cold air outlet 77. Therefore, cold air at a low temperature flows to a back surface portion of the small freezing chamber container 45, and foods are likely to be exposed to a lower temperature in this back surface portion compared to a position other than the back surface portion of the small freezing chamber container 45.

Accordingly, in the refrigerator 1E of the fifth embodiment, the heat-insulating sheet 309, the heat-insulating sheet 310, and the heat-insulating sheet 311 are each adhered to the back surface portion and a rear side of the center of the bottom wall part in the first vegetable chamber container 42, the second vegetable chamber container 43, and the small freezing chamber container 45, respectively. With this configuration, foods of these back surface portions can be inhibited from being exposed to a low temperature due to the cold air blown out.

According to the refrigerator 1E of the fifth embodiment, the partition wall heat-insulating sheets 309, 310, and 311 are each attached to the back surface portion and a rear side of the center of the bottom wall part of the containers in which the cold air hits strongly. Therefore, only the foods on the back side being excessively cooled can be inhibited in the vegetable chamber 82 and the small freezing chamber 84.

### Sixth Embodiment

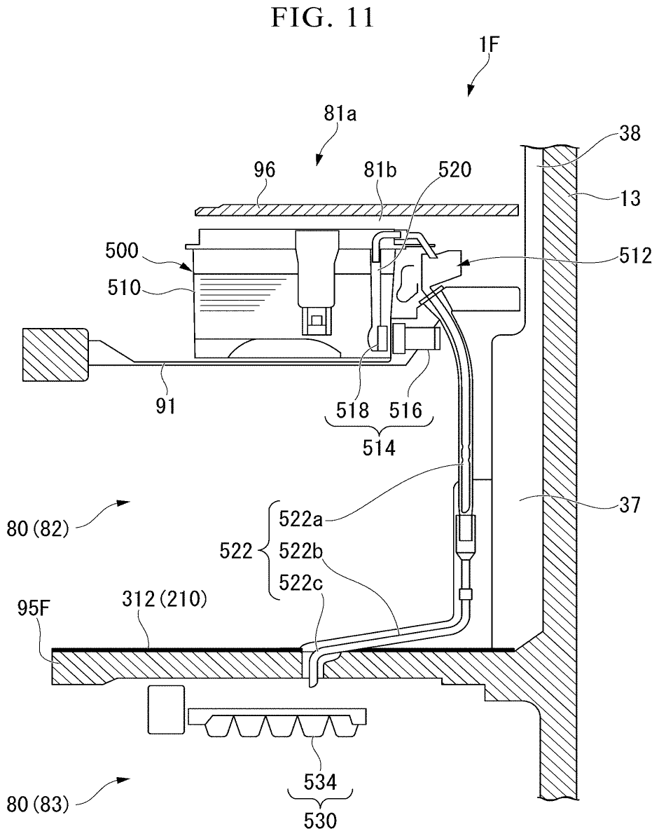

FIG. 11 is a cross-sectional view showing a refrigerator 1F of a sixth embodiment. FIG. 11 is a cross section at a position corresponding to F11-F11 of FIG. 1. The refrigerator 1F of the sixth embodiment is different from the refrigerator 1 of the first embodiment in that a partition wall 95F is provided instead of the partition wall 95, and a heat-insulating sheet 312 is adhered to the partition wall 95F around a water supply pipe 522 on the partition wall 95F. Other configurations of the refrigerator 1F are the same as those of the refrigerator 1 of the first embodiment.

Hereinafter, water supply from an ice-making water supply tank module 500 to an automatic ice-making module 530 via the water supply pipe 522 will be described. The ice-making water supply tank module 500 is provided in an ice-making water supply tank chamber 81b of a refrigerator chamber 81. The ice-making water supply tank module 500 includes an ice-making water supply tank 510, a water receiving container 512, a water supply mechanism 514, a pumping pipe 520, and a water supply pipe 522. As illustrated in the figure, the water receiving container 512 is installed at a rear portion of the ice-making water supply tank chamber 81b.

The water supply mechanism 514 is provided between the ice-making water supply tank chamber 81b and the water receiving container 512. The water supply mechanism 514 supplies water of the ice-making water supply tank 510 of the ice-making water supply tank chamber 81b to the water receiving container 512. The water supply mechanism 514, for example, pumps up the water in the ice-making water supply tank 510 due to an operation of a pump 518 driven by a pump motor 516 and supplies the pumped water to the water receiving container 512 by the pumping pipe 520. The water supplied to the water receiving container 512 is supplied to an ice tray 534 of the automatic ice-making module 530 of an ice-making chamber 83 via the water supply pipe 522. The automatic ice-making module 530 is an example of an “ice-making machine”. The water supply pipe 522 is an example of a “water supply pipe” that guides the water stored in the ice-making water supply tank 510 (water storage container) toward the automatic ice-making module 530 (ice-making machine). The “water supply pipe” may also be a hose or the like instead of the water supply pipe.

The water supply pipe 522 includes a water supply pipe vertical part 522a, a water supply pipe inclined part 522b, and a water supply pipe outlet part 522c. The water supply pipe vertical part 522a is a pipe portion having an upstream end connected to the water receiving container 512 and extending in a substantially vertical direction. The water supply pipe inclined part 522b is a pipe portion that has an upstream end connected to a downstream end of the water supply pipe vertical part 522a and is inclined to be gradually lowered toward a front side in a depth direction of the refrigerator 1. The water supply pipe outlet part 522c has an upstream end connected to a downstream end of the water supply pipe inclined part 522b. The water supply pipe outlet part 522c penetrates the partition wall 95F in a substantially vertical direction. A downstream end of the water supply pipe outlet part 522c is positioned above the ice tray 534 of the automatic ice-making module 530 and is configured so that the water supplied through the water supply pipe 522 is poured into the ice tray 534.

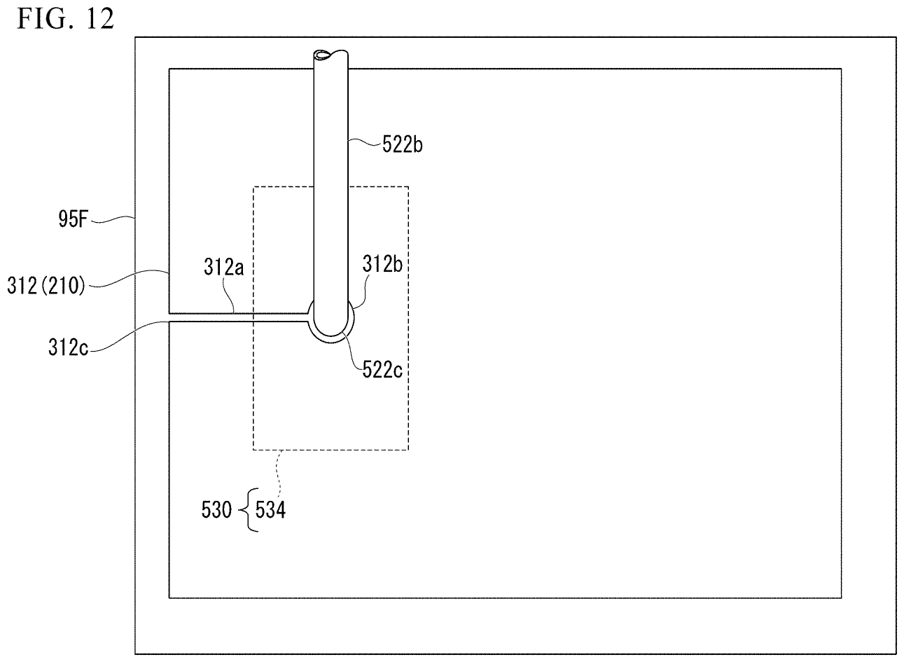

FIG. 12 is a top view of the partition wall 95F of the refrigerator 1F of the sixth embodiment. As illustrated in FIGS. 11 and 12, the water supplied from the ice-making water supply tank module 500 passes through the water supply pipe vertical part 522a and the water supply pipe inclined part 522b of the water supply pipe 522 and is supplied from the water supply pipe outlet part 522c onto the ice tray 534 of the automatic ice-making module 530. At this time, an upper side of the partition wall 95F is the vegetable chamber 82 in a refrigeration temperature zone, and a lower side of the partition wall 95F is the ice-making chamber 83 in a freezing temperature zone. The automatic ice-making module 530 is provided in the ice-making chamber 83. Therefore, there is a likelihood that the water supplied from the ice-making water supply tank module 500 to the automatic ice-making module 530 via the water supply pipe 522 will be frozen by cold air in the ice-making chamber 83.

The ice-making chamber 83, a small freezing chamber 84, and a main freezing chamber 85 are all storage chambers in the freezing temperature zone (for example, a negative temperature zone of minus 10 to minus 20° C.). The vegetable chamber 82 is vertically partitioned from the ice-making chamber 83 and the small freezing chamber 84 by the partition wall 95F. As illustrated in FIG. 1, a drawer-type ice-making chamber door 24 is provided on a front surface portion of the ice-making chamber 83, and an ice-making chamber container 44 (see FIG. 3) is connected to a back surface portion of the ice-making chamber door 24. A drawer-type small freezing chamber door 25 to which a small freezing chamber container 45 is connected is also provided on a front surface portion of the small freezing chamber 84. That is, the ice-making chamber 83 (third storage chamber) is cooled to the freezing temperature zone that is lower than the refrigeration temperature zone of the refrigerator chamber 81 (first storage chamber).

In the refrigerator 1F of the sixth embodiment, the heat-insulating sheet 312 is adhered to an upper surface of the partition wall 95F. That is, the heat-insulating sheet 312 is provided between the ice-making water supply tank 510 and the automatic ice-making module 530.

The heat-insulating sheet 312 is formed of a specific heat-insulating material 210. The heat-insulating sheet 312 is formed in a sheet shape and has flexibility. A water supply pipe insertion hole 312b is provided in the partition wall heat-insulating sheet 312. On the partition wall heat-insulating sheet 312, a slit 312a is provided to be connected to the water supply pipe insertion hole 312b. The slit 312a connects the water supply pipe insertion hole 312b and an outer edge 312c of the heat-insulating sheet 312. Thereby, even after the water supply pipe 522 is installed, when the water supply pipe 522 is pushed into the slit 312a the water supply pipe 522 can be installed to pass through the heat-insulating sheet 312 by causing the water supply pipe outlet part 522c of the water supply pipe 522 to pass through the water supply pipe insertion hole 312b.

That is, when the heat-insulating sheet 312 allows the water supply pipe 522 to pass through the slit 312a, the heat-insulating sheet 312 can be disposed between the ice-making water supply tank 510 and the automatic ice-making module 530. The heat-insulating sheet 312 is “an example of a heat-insulating member” positioned between the ice-making water supply tank 510 (water storage container) and the automatic ice-making module 530 (ice-making machine).

After causing the water supply pipe 522 to pass through the water supply pipe insertion hole 312b of the heat-insulating sheet 312, the heat-insulating sheet 312 can be adhered to the upper surface of the partition wall 95F with an adhesive or a double-sided tape. The water supply pipe insertion hole 312b is an example of a hole. Further, the heat-insulating sheet 312 may have a notch through which the water supply pipe 522 is passed instead of having the hole through which the water supply pipe 522 is passed.

A size of the heat-insulating sheet 312 is preferably a size enough to cover substantially the entire partition wall 95F. The size of the heat-insulating sheet 312 may be a size that covers a part of the partition wall 95F.

The heat-insulating sheet 312 may be provided on a lower surface of the partition wall 95F instead of the configuration in which it is attached to the upper surface of the partition wall 95F. The heat-insulating sheet 312 may be provided on either one or both of the upper surface and the lower surface of the partition wall 95F.

In the refrigerator 1F of the sixth embodiment, the heat-insulating sheet 312 is adhered to the upper surface of the partition wall 95F. Therefore, the water supplied from the ice-making water supply tank module 500 to the automatic ice-making module 530 via the water supply pipe 522 can be inhibited from being frozen by the cold air of the ice-making chamber 83. Therefore, a heater disposed near the water supply pipe 522 or the like can be omitted or downsized, and reduction in costs of the refrigerator 1F can be achieved.

### Seventh Embodiment

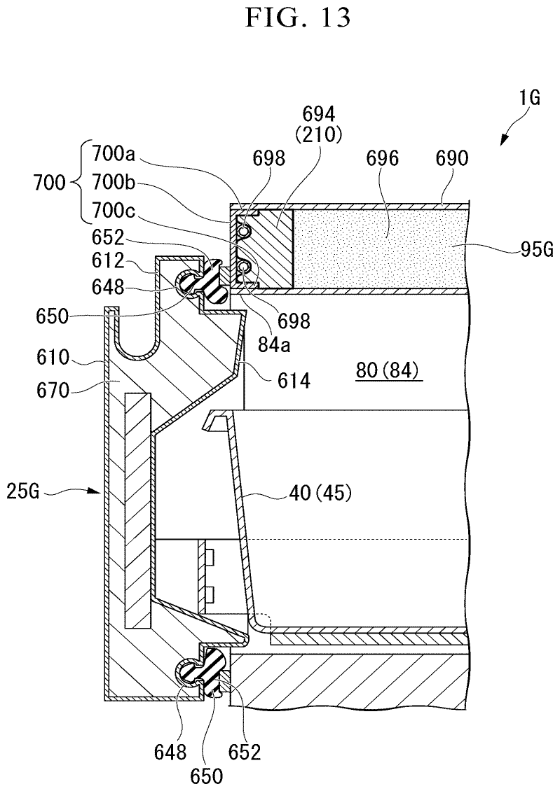

FIG. 13 is a cross-sectional view showing a small freezing chamber door 25G and a partition wall 95G of a refrigerator 1G of a seventh embodiment. The refrigerator 1G of the seventh embodiment is different from the refrigerator 1 of the first embodiment in that the partition wall 95G is provided instead of the partition wall 95. Other configurations of the refrigerator 1G of the seventh embodiment are the same as those of the refrigerator 1 of the first embodiment.

A front surface opening 84a of a small freezing chamber 84 is covered by a sliding door type small freezing chamber door 25G such that it can be opened and closed. The small freezing chamber door 25G includes a sash 612, an outer plate 610, an inner plate 614, a gasket 650, and a heat-insulating material 670. The sash 612 constitutes an outer frame of the small freezing chamber door 25G. The outer plate 610 constitutes a front surface side of the small freezing chamber door 25G. The inner plate 614 constitutes a back surface side of the small freezing chamber door 25G. The gasket 650 is provided on a circumferential edge of a back surface portion of the small freezing chamber door 25G.

When the small freezing chamber door 25G is covered, the gasket 650 hermetically seals between the back surface portion of the small freezing chamber door 25G and a circumferential edge of the front surface opening 84a of the small freezing chamber 84. The small freezing chamber door 25G is supported by a housing 10 of the refrigerator 1G to be movable by a rail (not illustrated).

The inner plate 614 is exposed to the small freezing chamber 84. The heat-insulating material 670 is provided between the outer plate 610 and the inner plate 614. The heat-insulating material 670 includes, for example, a foam insulating material such as urethane foam. A mounting recessed groove 648 is provided on a circumferential edge portion of the inner plate 614. The gasket 650 is mounted in the mounting recessed groove 648. The gasket 650 includes a magnet part 652. When the small freezing chamber door 25G is covered, the magnet part 652 is adsorbed to a front surface member 700 on a circumferential edge of the front surface opening 84a of the small freezing chamber 84, and thereby hermetically sealing between the back surface portion of the small freezing chamber door 25G and the circumferential edge of the front surface opening 84a of the small freezing chamber 84.

The partition wall 95G that partitions a vegetable chamber 82 and the small freezing chamber 84 includes an inner box 690, a first insulating member 694, a second insulating member 696, a dew-proof pipe 698, and the front surface member 700. The partition wall 95G forms a bottom wall of the vegetable chamber 82 and forms a ceiling wall of the small freezing chamber 84. The inner box 690 is a member such as a synthetic resin or the like that constitutes an outer shape of the partition wall 95G.

At least a part of the front surface member 700 is exposed to the outside of the housing 10. The dew-proof pipe 698 is provided behind the front surface member 700. Some of a refrigerant compressed by a compressor 50 is supplied to the dew-proof pipe 698 to warm the front surface member 700. The first insulating member 694 and the second insulating member 696 are provided on a side opposite to the front surface member 700 with respect to the dew-proof pipe 698.

The first insulating member 694 and the front surface member 700 are provided at a front end portion of the partition wall 95G. The dew-proof pipe 698 is provided to be disposed between the first insulating member 694 and the front surface member 700 at a position away from an adsorption part of the gasket 650 in the front surface opening 84a of the small freezing chamber 84. The dew-proof pipe 698 crosses the partition wall 95 in a width direction. The dew-proof pipe 698 conducts heat to the front surface member 700 to inhibit dew condensation on the circumferential edge of the front surface opening 84a of the small freezing chamber 84.

In the inner box 690, the first insulating member 694 is provided on a front side of the refrigerator 1G in a depth direction. The first insulating member 694 is formed of a specific heat-insulating material 210 and has elasticity. According to such a configuration, a temperature of the small freezing chamber 84 is not easily transmitted to the front surface member 700, and occurrence of dew condensation on a surface of the front surface member 700 can be inhibited. The front surface member 700 is an example of a “surface member”. The dew-proof pipe 698 is an example of a “dew-proof member”.

In the inner box 690, the second insulating member 696 is provided on a back side of the refrigerator 1G in the depth direction. The second insulating member 696 is formed of a material different from that of the specific heat-insulating material 210. The second insulating member 696 is formed of, for example, a foam insulating material such as urethane foam.

The first insulating member 694 has elasticity. The first insulating member 694 is positioned on a side of the dew-proof pipe 698 opposite to the front surface member 700. The first insulating member 694 is positioned between the dew-proof pipe 698 and the second insulating member 696. The first insulating member 694 is sandwiched between the dew-proof pipe 698 and the second insulating member 696 and is compressed between the dew-proof pipe 698 and the second insulating member 696.

The first insulating member 694 is sandwiched and compressed between the dew-proof pipe 698 and the second insulating member 696 when, for example, the second insulating member 696, which is a foam insulating material, foams. The first insulating member 694 exerts an elastic force due to the compression on the dew-proof pipe 698 to press the dew-proof pipe 698 toward a back surface of the front surface member 700. Thereby, the dew-proof pipe 698 comes into contact with the back surface of the front surface member 700, and thermal connectivity between the dew-proof pipe 698 and the front surface member 700 is improved. As a result, heat of the dew-proof pipe 698 is easily transmitted to the back surface of the front surface member 700. Thereby, occurrence of dew condensation on the surface of the front surface member 700 can be inhibited at an even higher level. An example of an “insulating part” is configured by the first insulating member 694 and the second insulating member 696. The first insulating member 694 is an example of a “first portion.” The second insulating member 696 is an example of a “second portion.”

The second insulating member 696 may have elasticity. In this case, the first insulating member 694 may have higher elasticity than the second insulating member 696. In this case, when the first insulating member 694 having higher elasticity comes into direct contact with the dew-proof pipe 698, thermal conductivity between the dew-proof pipe 698 and the front surface member 700 is further enhanced.

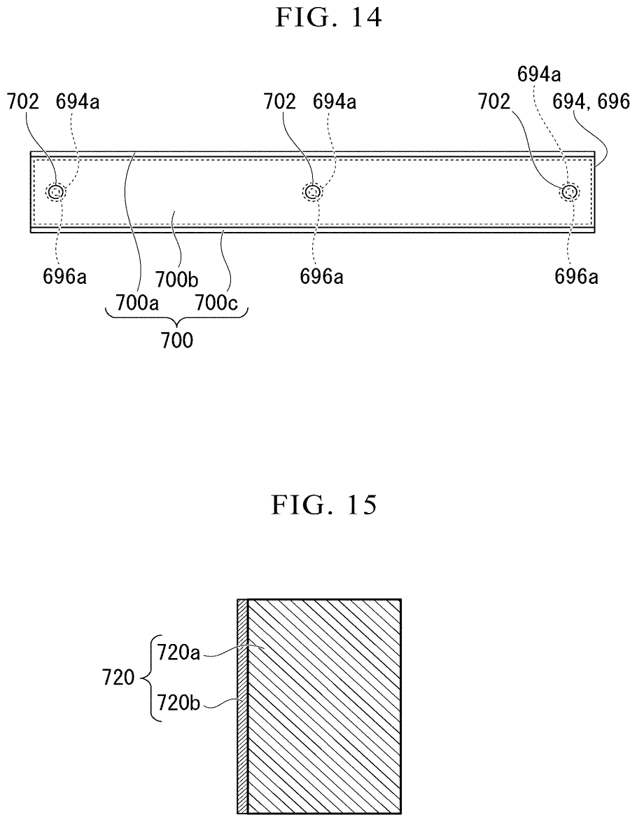

FIG. 14 is a view of the front surface member 700 from the front of the refrigerator 1G. The front surface member 700 is a member made by bending a flat plate-shaped member made of a material having high thermal conductivity such as a metal into a U shape. The front surface member 700 includes a first bent part 700a, a flat surface portion 700b, and a second bent part 700c. When the front surface member 700 is attached to the inner box 690 of the partition wall 95G, the first bent part 700a comes into contact with an inner side of an upper surface portion of the inner box 690, and the second bent part 700c comes into contact with an inner side of a lower surface portion of the inner box 690.

As illustrated in FIG. 14, a plurality of holes 702 are formed on the front surface member 700. The plurality of holes 702 are formed at substantially equal intervals in a width direction of the refrigerator 1G at a substantially center in a height direction of the refrigerator 1G. Corresponding to positions of the plurality of holes 702, holes (screw holes) 696a are provided in a receiving member made of a metal embedded in the second insulating member 696. The front surface member 700 and the second insulating member 696 are fixed by fastening members such as screws, bolts, or the like. Corresponding to the positions of the plurality of holes 702, the first insulating member 694 has insertion holes 694a through which the above-described fastening members are passed.

In the partition wall 95G, since the second insulating member 696 formed of the specific heat-insulating material 210 is in contact with the dew-proof pipe 698 and the front surface member 700, heat is not transmitted to the small freezing chamber 84.

Thereby, energy saving performance of the refrigerator 1G can be improved.

### First Modified Example of Seventh Embodiment

FIG. 15 is a cross-sectional view showing a first insulating member 720 of a refrigerator 1H of a first modified example of the seventh embodiment. The refrigerator 1H of the first modified example is different from the refrigerator 1G of the seventh embodiment in that the first insulating member 720 is provided instead of the first insulating member 694. Other configurations of the refrigerator 1H of the first modified example are the same as those of the refrigerator 1G of the seventh embodiment.

The first insulating member 720 includes a main body part 720a and a metal part 720b. Similarly to the first insulating member 694, the main body part 720a is formed of the specific heat-insulating material 210 and has elasticity. Similarly to the front surface member 700, the metal part 720b is formed of a member having high thermal conductivity such as a metal. The metal part 720b is provided on a surface of at least a part of the main body part 720a. In the present embodiment, the metal part 720b is provided on a surface of the main body part 720a facing the dew-proof pipe 698 and the front surface member 700. The metal part 720b is positioned between the main body part 720a, and the dew-proof pipe 698 and the front surface member 700. The metal part 720b is a thin metal layer (for example, a metal foil) and has flexibility. The metal part 720b can be deformed following elastic deformation of the main body part 720a.

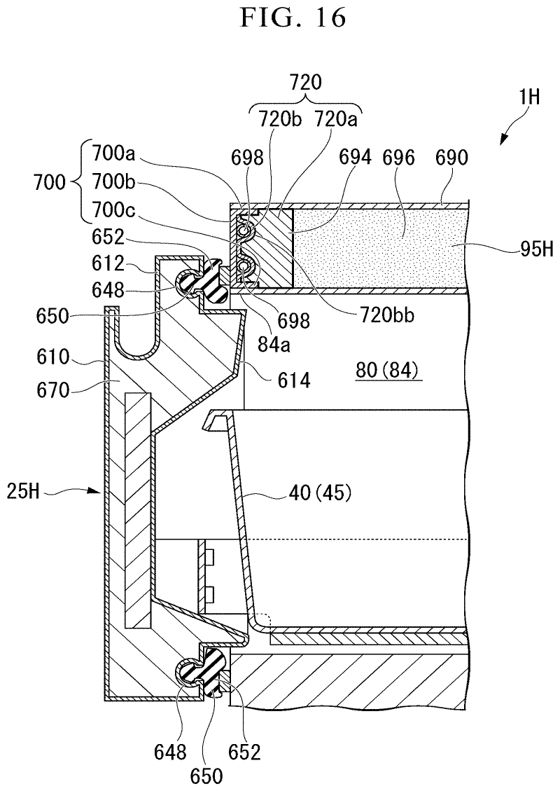

FIG. 16 is a cross-sectional view showing a small freezing chamber door 25H and a partition wall 95H of the refrigerator 1H of the first modified example of the seventh embodiment. The metal part 720b includes a first portion 720ba and a second portion 720bb. The first portion 720ba faces the dew-proof pipe 698 in a front-rear direction of the refrigerator 1H. The second portion 720bb is positioned away from the dew-proof pipe 698 and faces the back surface of the front surface member 700 in the front-rear direction of the refrigerator 1H. The main body part 720a is sandwiched and compressed between the first portion 720ba and the second portion 720bb of the metal part 720b and the second insulating member 696.

The first insulating member 720 exerts an elastic force due to compression of the main body part 720a on the first portion 720ba of the metal part 720b to presses the first portion 720ba of the metal part 720b toward the dew-proof pipe 698. For example, the first portion 720ba of the metal part 720b is deformed to wrap a part of an outer circumferential surface of the dew-proof pipe 698 and is in contact with the outer circumferential surface of the dew-proof pipe 698. Thereby, thermal connectivity between the metal part 720b and the dew-proof pipe 698 is improved.

Similarly, the first insulating member 720 exerts an elastic force due to compression of the main body part 720a on the second portion 720bb of the metal part 720b to press the second portion 720bb of the metal part 720b toward the back surface of the front surface member 700. Thereby, the metal part 720b is in contact with the back surface of the front surface member 700, and thermal connectivity between the metal part 720b and the back surface of the front surface member 700 is improved. As a result, the dew-proof pipe 698 and the back surface of the front surface member 700 are more firmly thermally connected via the metal part 720b, and some of heat of the dew-proof pipe 698 is transmitted to the back surface of the front surface member 700 via the metal part 720b. Thereby, occurrence of dew condensation on the surface of the front surface member 700 can be inhibited at an even higher level. The dew-proof pipe 698 and the back surface of the front surface member 700, the first portion 720ba of the metal part 720b and the dew-proof pipe 698, and the second portion 720bb of the metal part 720b and the back surface of the front surface member 700 may be in indirect contact with each other with a member having satisfactory thermal conductivity interposed therebetween instead of being in direct contact with each other.

According to such a configuration, in the partition wall 95H, the metal part 720b of the first insulating member 720 is in contact with the dew-proof pipe 698 and the front surface member 700. Thereby, heat of the dew-proof pipe 698 on the front surface member 700 side is directly conducted to the front surface member 700, and heat of the dew-proof pipe 698 on the metal part 720b side is conducted to the front surface member 700 via the metal part 720b. Thereby, heat of the entire circumference of the dew-proof pipe 698 can be efficiently conducted to the front surface member 700.

Since the main body part 720a is provided on a back side of the metal part 720b, heat of the dew-proof pipe 698 is not transmitted to the small freezing chamber 84. Thereby, energy saving performance of the refrigerator 1H is improved while improving efficiency of thermal conduction from the dew-proof pipe 698 to the front surface member 700.

### Second Modified Example of Seventh Embodiment

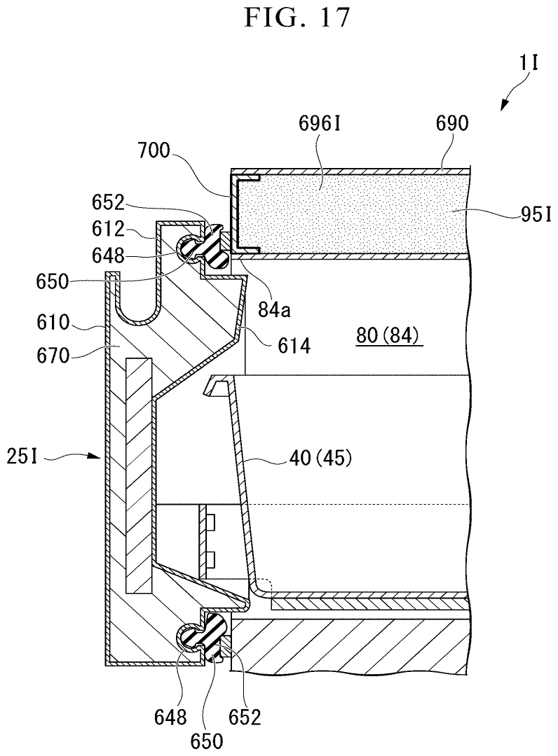

FIG. 17 is a cross-sectional view showing a small freezing chamber door 25I and a partition wall 95I of a refrigerator 1I of a second modified example of the seventh embodiment. The refrigerator 1I of the second modified example is different from the refrigerator 1G of the seventh embodiment in that the partition wall 95I is provided instead of the partition wall 95G. Other configurations of the refrigerator 1I of the second modified example are the same as those of the refrigerator 1G of the seventh embodiment.

The partition wall 95I that separates the vegetable chamber 82 and the small freezing chamber 84 includes the inner box 690, a heat-insulating member 696I, and the front surface member 700. The insulating member 696I is, for example, a foam insulating material. The partition wall 95I does not include the first insulating member 694 and the dew-proof pipe 698. In the present modified example, since the front surface member 700 is formed of the specific heat-insulating material 210 and has high heat insulation performance, dew condensation can be inhibited even if the dew-proof pipe 698 is not provided.

According to at least one embodiment described above, since the first insulating member, of which at least a part is formed of a heat-insulating material containing an aerogel, a xerogel, or a cryogel, partitions the inside of the first storage chamber of the refrigerator into a first storage portion and a second storage portion that is cooled to a temperature zone lower than that of the first storage portion, improvement in heat insulation can be achieved.

While preferred embodiments of the present invention have been described, it should be understood that these embodiments are exemplary of the invention and are not intended to limit the scope of the invention. The embodiments may be implemented in various other forms, and various omissions, substitutions, and modifications can be made within a range not departing from the gist of the invention. The embodiments and modifications thereof should be regarded as being included within the scope and gist of the invention and included in the invention described in the claims and equivalent scope thereof.

### REFERENCE SIGNS LIST

1, 1A to 1I Refrigerator
10 Housing
20 (21 to 26) Door
40 (41 to 47) container
80 (81 to 85) Storage chamber
91, 91a Partition wall
94c Front vent
94d Rear vent
95, 95F to 95I Partition wall
96, 96a Chilled chamber upper surface partition portion
97 Ice-making water supply tank chamber partition wall
98 Chilled chamber lid
210 Specific heat-insulating material
301 to 312 First to twelfth insulating sheet
312a Slit
312b Water supply pipe insertion hole
312c Outer edge
500 Ice-making water supply tank module
522 Water supply pipe
530 Automatic ice-making module
694 First insulating member
696 Second insulating member
698 Dew-proof pipe
700 Front surface member
720a Main body part
720b Metal part

1. A refrigerator comprising:
a housing including a first storage chamber; and
a first partition portion disposed in the first storage chamber and configured to partition the inside of the first storage chamber into at least a first storage portion and a second storage portion which is cooled to a temperature zone lower than that of the first storage portion, wherein
at least a part of the first partition portion is formed of a heat-insulating material containing an aerogel, a xerogel, or a cryogel.

2. The refrigerator according to claim 1, wherein
the second storage portion is provided below at least part of the first storage portion,
the first partition portion includes a ceiling plate portion which is located between the first storage portion and the second storage portion and forms a ceiling portion of the second storage portion, and
the ceiling plate portion is formed of the heat-insulating material over an entire thickness of the ceiling plate portion.

3. The refrigerator according to claim 1, wherein
the second storage portion is provided below at least part of the first storage portion,
the first partition portion includes a ceiling plate portion which is located between the first storage portion and the second storage portion and forms a ceiling portion of the second storage portion and a lid which is located on a front side of the second storage portion and configured to cover the second storage portion to be openable, and
at least a part of the lid is formed of a heat-insulating material.

4. The refrigerator according to claim 3, wherein the ceiling plate portion is formed of the heat-insulating material over an entire thickness of the ceiling plate portion.

5. The refrigerator according to claim 1, further comprising:
a plurality of trays including a first tray and a second tray disposed above the first tray and disposed in the second storage portion, wherein
at least a part of a bottom portion of the second tray is formed of the heat-insulating material.

6. The refrigerator according to claim 1, further comprising:
a water storage container which is disposed on a side of the second storage portion and stores ice-making water,
wherein, the first partition portion includes a side plate which is disposed between the water storage container and the second storage portion, and
at least part of the side plate is formed of the heat-insulating material.

7. The refrigerator according to claim 1, wherein
the second storage portion is provided below at least part of the first storage portion,
the housing includes a second storage chamber provided below the second storage portion,
the refrigerator includes a second partition portion disposed between the first storage chamber and the second storage chamber and having a first region positioned on a lower side of the second storage portion and a second region positioned on a front side of the first region, and
at least a part of the first region of the second partition portion is formed of a heat-insulating material.

8. The refrigerator according to claim 7, wherein
at least a part of the second region of the second partition portion is formed of a material having lower heat insulation than the heat-insulating material.

9. The refrigerator according to claim 1, wherein
the housing includes a third storage chamber cooled to a temperature zone which is lower than that of the first storage chamber,
the water storage container is disposed in the first storage chamber,
the refrigerator further comprises:
an ice-making machine disposed in the third storage chamber;
a water supply pipe guiding water stored in the water storage container toward the ice-making machine; and
a heat-insulating member positioned between the water storage container and the ice-making machine, and
the heat-insulating member is formed of the heat-insulating material and a hole or a notch through which the water supply pipe is passed is provided in the insulating member.

10. The refrigerator according to claim 9, wherein
the heat-insulating member has a slit connecting the hole and an outer edge of the heat-insulating member, and
the heat-insulating member is able to be disposed between the water storage container and the ice-making machine by causing the water supply pipe to pass through the slit.

11. The refrigerator according to claim 1, further comprising:
a surface member in which at least part of the surface member is exposed to an outside of the housing;
a dew-proof member which is provided behind the surface member; and
an heat-insulating part provided on a side of the dew-proof member opposite to the surface member, wherein
the heat-insulating part includes a first portion formed of the heat-insulating material and having elasticity and a second portion formed of a material different from that of the heat-insulating material, and
the first portion is sandwiched between the dew-proof member and the second portion and presses the dew-proof member toward a back surface of the surface member due to an elastic force.

12. The refrigerator according to claim 11, wherein
the first portion includes a main body part formed of the heat-insulating material and a metal part provided on a portion of a surface of the main body part facing the dew-proof member, and
the first portion is sandwiched between the second portion and the dew-proof member and presses the metal part toward the dew-proof member and the back surface of the surface member.

13. A refrigerator comprising:
a housing including:
a first storage chamber having a first storage portion and a second storage portion provided below at least part of the first storage portion and cooled to a temperature zone that is lower than that of the first storage portion;
a second storage chamber provided below the first storage chamber; and
a partition portion disposed between the first storage chamber and the second storage chamber and including a first region which is located on a lower side of the second storage portion and a second region which is located on a front side of the first region, wherein
at least part of the first region of the partition portion is formed of a heat-insulating material containing an aerogel, a xerogel, or a cryogel.

14. A refrigerator comprising:
a housing including a first storage chamber and a second storage chamber;
a water storage container disposed in the first storage chamber and in which water is stored;
an ice-making machine disposed in the second storage chamber;
a water supply pipe guiding the water stored in the water storage container toward the ice-making machine; and
a heat-insulating member provided between the water storage container and the ice-making machine, wherein
the heat-insulating member is formed of a heat-insulating material containing an aerogel, a xerogel, or a cryogel and the heat-insulating member includes a hole or a notch through which the water supply pipe is passed.

15. A refrigerator comprising:
a housing;
a surface member in which at least part of the surface member is exposed to an outside of the housing;
a dew-proof member provided behind the surface member; and
a heat-insulating part provided on a side of the dew-proof member opposite to the surface member, wherein
the heat-insulating part includes a first portion formed of a heat-insulating material containing an aerogel, a xerogel, or a cryogel and having elasticity and a second portion formed of a material different from that of the heat-insulating material, and
the first portion is sandwiched between the dew-proof member and the second portion and presses the dew-proof member toward a back surface of the surface member due to an elastic force.
